(19) United States
(12) Patent Application Publication
(10) Pub. No.: US 2023/0292040 A1
(43) Pub. Date: Sep. 14, 2023

(54) SPEAKER ENCLOSURE ATMOSPHERIC PRESSURE EQUALIZATION

(71) Applicant: Joseph B. Crosswell, Boone, NC (US)

(72) Inventor: Joseph B. Crosswell, Boone, NC (US)

(21) Appl. No.: 17/692,523

(22) Filed: Mar. 11, 2022

(51) Int. Cl. H04R 1/40; H04R 1/28; G10K 11/178

(52) U.S. Cl. CPC H04R 1/403; H04R 1/2803; G10K 11/178

(57) ABSTRACT

An audio driver assembly which equalizes the atmospheric pressure in a sealed enclosure and is capable of canceling external sounds in a non-sealed enclosure, resulting in the improvement of the reproduction of sound quality through a dual cone audio speaker.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

### Field of the Invention

The present invention relates to an audio driver assembly which equalizes the atmospheric pressure or creates noise cancellation in a sealed enclosure, such as a speaker cabinet.

### Description of Related Art

The pressure created by speakers, i.e., audio drivers in enclosures, has been a constant problem in the industry. Pressure comes from the movement of the speaker in the enclosure. The fewer the pressure changes, the better clarity, transparency, and decibels (Db) that are released from the audio speaker in the reproduction of audio.

Audio reproduction incorporates the original designs of active speakers, employing magnets and cone materials to transfer the electronic waves through voice coils, moving the cone material to produce audible sounds the ear can receive. To overcome the back-wave problems inherent with speaker systems, an array of enclosures have been developed, with varying formulas and mathematical theories to improve the output of the speakers (i.e., to improve the sound by reducing internal pressure).

A push-pull design where at least two speakers are wired out of phase was developed and applied in various patents since the 1920's. For example, these patents cover designs wherein the loudspeakers are facing each other with the same phasing. Another example is a design with loudspeakers facing opposite directions and out of phase; this allows the two loudspeakers to act as one. Even with the improved response, the need to reduce changes in air pressure in an enclosure still remains an issue.

Engineers, inventors, and mathematicians have creatively changed and improved the reproduction of audio by decreasing changes in enclosure pressure, but the paradigm for accomplishing that has not changed. While several designs have been created over the years, the absolute problem of changes in enclosure pressure still exists.

It is well known that animals, such as dogs, are frightened by loud or sharp noises. Accordingly, a speaker system which allows for rich, full frequency reproduction in an enclosure with little to no pressure changes or for noise cancellation for an animal enclosure is still something the industry is searching for and users would appreciate.

### BRIEF SUMMARY OF THE INVENTION

The present invention relates to a speaker system, which solves the problems noted above, wherein two audio drivers utilize opposite positive and negative sides of the same stationary magnet in a sealed enclosure (i.e., a single speaker with two cones), and are fed the same audio signal resulting in one audio driver being 180° out of phase with the other audio driver. This eliminates the normal changes in pressure. Since it is also noise canceling, it can be utilized to counter offensive or unwanted sounds by canceling noise (e.g., thunder or a dog barking in a dog house or other open enclosure).

Accordingly, in one embodiment, there is a speaker system for equalizing pressure in a speaker enclosure comprising:
a) a full spectrum active speaker having two speaker cones, the speaker comprising:
   i. a voice coil associated with each speaker cone, which creates an electromagnetic field from an audio signal passed through the voice coil; and
b) a single fixed magnet having a negative pole and a positive pole, wherein the negative pole is positioned at a rear end of one of the speaker cones, and wherein the positive pole is positioned at a rear end of the other speaker cone; and
c) a sealed enclosure for the speaker cones and magnet, wherein each of the speaker cones are exposed externally and connected to an audio source signal, which is 180° out of phase with the other.

In another embodiment, there is a speaker system for cancellation of a live noise in an animal enclosure comprising:
a) a full spectrum active speaker having two speaker cones, the speaker comprising:
   i. a voice coil associated with each speaker cone, which creates an electromagnetic field from an audio signal passed through the voice coil; and
b) a single fixed magnet having a negative pole and a positive pole, wherein the negative pole is positioned at a rear end of one of the speaker cones, and wherein the positive pole is positioned at a rear end of the other speaker cone;
c) a sealed enclosure for the speaker cones and magnet, wherein each of the speaker cones are exposed externally and connected to an audio source signal, which is 180° out of phase with the other; and
d) a system for collection of the live noise, which system feeds the live noise to the speaker.

### BRIEF DESCRIPTION OF THE DRAWINGS

FIG. 1 is a schematic view of the speaker system of the present invention.

FIG. 2 is a perspective view of an embodiment for noise cancellation in an animal enclosure.

### DETAILED DESCRIPTION OF THE INVENTION

While this invention is susceptible to embodiment in many different forms, there is shown in the drawings, and will herein be described in detail, specific embodiments with the understanding that the present disclosure of such embodiments is to be considered as an example of the principles and not intended to limit the invention to the specific embodiments shown and described. In the description below, like reference numerals are used to describe the same, similar, or corresponding parts in the several views of the drawings. This detailed description defines the meaning of the terms used herein and specifically describes embodiments in order for those skilled in the art to practice the invention.

### Definitions

The terms “about” and “essentially” mean±10 percent.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

The term “comprising” is not intended to limit inventions to only claiming the present invention with such comprising language. Any invention using the term comprising could be separated into one or more claims using “consisting” or “consisting of” claim language and is so intended.

Reference throughout this document to “one embodiment”, “certain embodiments”, “an embodiment”, or similar terms means that a particular feature, structure, or characteristic described in connection with the embodiment is included in at least one embodiment of the present invention. Thus, the appearances of such phrases in various places throughout this specification are not necessarily all referring to the same embodiment. Furthermore, the particular features, structures, or characteristics may be combined in any suitable manner in one or more embodiments without limitation.

The term “or”, as used herein, is to be interpreted as an inclusive or meaning any one or any combination. Therefore, “A, B, or C” means any of the following: “A; B; C; A and B; A and C; B and C; A, B, and C”. An exception to this definition will occur only when a combination of elements, functions, steps, or acts are in some way inherently mutually exclusive.

The drawings featured in the figures are for the purpose of illustrating certain convenient embodiments of the present invention and are not to be considered as limitation thereto. The term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein, and use of the term “means” is not intended to be limiting.

As used herein, the term “full spectrum speaker” refers to a driver, which reproduces as much of the audible frequency range as possible through the speaker cone. The frequency range of these drivers is often maximized through the use of a whizzer cone and other means, other than electronic crossovers. Typically, that range is considered to be greater than about 40 Hz in the audible range up to about 20,000 Hz.

As used herein the term “speaker enclosure” refers to an enclosure designed for speaker use that is sealed. The enclosure can be made of any suitable material such as wood, composites, or any other material used for speaker enclosures known in the art. The housing can be relatively any size, but in one embodiment, it is less than about 600 sq. inches and in another embodiment, it is about 500 to 510 sq. inches in volume. The specific dimensions depend on the particular use, as shown in the figures. So, when used in a chair arm, or similarly in a light fixture or other utility, a particular shape can be fitted. Such a shape is within the skill of the art, in view of this disclosure. The enclosure can include insulation or other acoustic materials normally utilized in a speaker enclosure, as known in the art. The minimum requirements are, of course, to enable the speaker arrangement of the present invention to be accommodated. In one embodiment, the enclosure is as small as possible to accommodate the speaker arrangement as claimed herein. The speaker of the present invention can be ported outside of the enclosure.

As used herein, the term “active speaker” refers to each speaker cone electrically connected to a powered audio source to reproduce an audio sound either from a live or recorded audio source.

As used herein, the term “speaker system” refers to two speaker cones in one speaker designed to reproduce sound from an audio signal. Each speaker cone has a voice coil. They are driven by opposite poles (positive and negative) of a single fixed magnet (i.e., a speaker with two opposing cones). The speaker cones operate within the magnetic field law by incorporating a static magnet on the rear end of the speaker. The magnet and the voice coil create an electromagnetic field for the audio signal that passes through each of the coils. The reaction between the two fields produces sound waves utilizing the speaker cones. Typically in a speaker system, all speakers use the same polarity and use a dedicated magnet for each speaker. In the present invention, the two speaker cones utilize the same fixed magnet, with one driven by the positive pole and the other driven by the negative pole (i.e., one speaker, two active cones). The speaker is fed a signal with the 2 voice coils 180° out of phase with each other. If a live audio signal is fed to the speaker in the present invention, there is a noise cancellation effect. This phase difference between the two cones and the pressure created by the speaker never changes if enclosed in a sealed airtight speaker enclosure. Each of the speaker cones is exposed to room air, but needs to be positioned such that a sealed airtight enclosure is maintained. The same audio signal is fed to both speaker cones. In one embodiment, there can be additional speakers such as a passive radiator, which does not cause pressure changes within the speaker enclosure.

As used herein, the term “equalizing pressure” refers to eliminating the change in atmospheric pressure present in the speaker enclosure, which leads to improved performance due to one of the cones being 180° out of phase with the other cone.

As used herein, the term “speaker cone” refers to the diaphragm of a speaker and is the main active area of the speaker. In the present invention, there is one speaker with two speaker cones, and one magnet. When activated by the voice coil, it pushes the air backwards and forwards to create the sound waves and pressure.

As used herein, the term “voice coil” refers to a coil of wire wrapped around a cylinder that accepts the current from the audio source. This current causes the voice coil to react with the speaker magnet, which moves that cylinder up and down. The speaker cone is attached to the cylinder, which produces air pressure when it moves while creating sound.

As used herein, the term “audio signal passed through a voice coil” refers to an electronic signal capable of driving a voice coil. The audio signal can come from at least two sources. One source is an audio signal that can be pre-recorded audio, for example when playing a musical recording. The second source is the audio signal that can come from a live source and is converted into an audio signal. For example, sound from thunder, a live band, or a person speaking, which is electronically converted to two audio signals 180° out of phase with one another.

As used herein, the term “fixed magnet” refers to making the speaker cone (or panel) of the speaker move, magnets are used to create an opposing magnetic field which creates vibrations. These vibrations are the sounds we hear. Speakers often contain large magnets inside of them, as a larger opposing magnetic field creates more vibrations. In typical speaker systems, there is a dedicated magnet for each speaker. In the present invention, there is one magnet for two cones arranged so the positive pole drives one of the voice coils and the negative pole of the magnet drives the voice coil of the other cone.

As used herein, the term “noise cancellation” refers to the elimination of unwanted noise in the surrounding environment using a noise canceling speaker of the present invention. A microphone picks up external sound and creates a signal to both speaker cones and since they are out of phase by 180°, it cancels the noise from the external source for anyone who is close to the audio speaker (e.g., a dog in a dog house). Normally this is done utilizing headphones, however with the present invention, headphones are not used or needed and anyone close to the speaker system or the animal enclosure will experience noise cancellation. In one embodiment, the speaker of the present invention is positioned near an animal, such as a dog, and utilized to cancel noise that frightens or upsets the animal. Examples include the sound of thunder, loud music, and other high-volume sounds.

### DRAWINGS

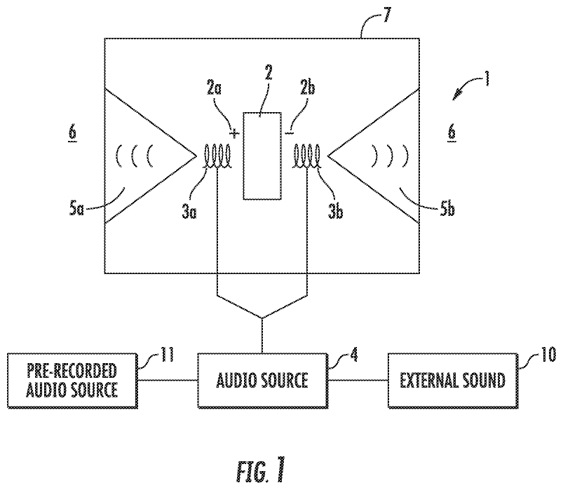

Now referring to the drawings, FIG. 1 is a schematic view of the speaker system 1 of the present invention. In this view, a single fixed magnet 2 has a positive pole 2a and a negative pole 2b. Voice coils 3a and 3b are positioned at opposite poles of magnet 2, and when fed by an audio source 4, cause the voice coils 3a and 3b to move, which in turn moves the speaker cones 5a and 5b out of phase by 180° with the other and reproduces sound. The speaker cones 5a and 5b are ported to the outside environment 6 and the speaker enclosure 7 is sealed.

In order to utilize the speaker system 1 of the present invention, each voice coil 3a and 3b are fed the same audio source 4 causing signals, which creates sound through the speaker cones 5a and 5b that are out of phase by 180° with the other, and wherein the audio source 4 is an external sound 10. The speaker system 1 will act as a noise cancellation device without the need for headphones. When fed pre-recorded audio source 11, the speaker system 1 produces sound without an accompanying change in pressure within the speaker enclosure 7, which in turn leads to better speaker system audio and quality.

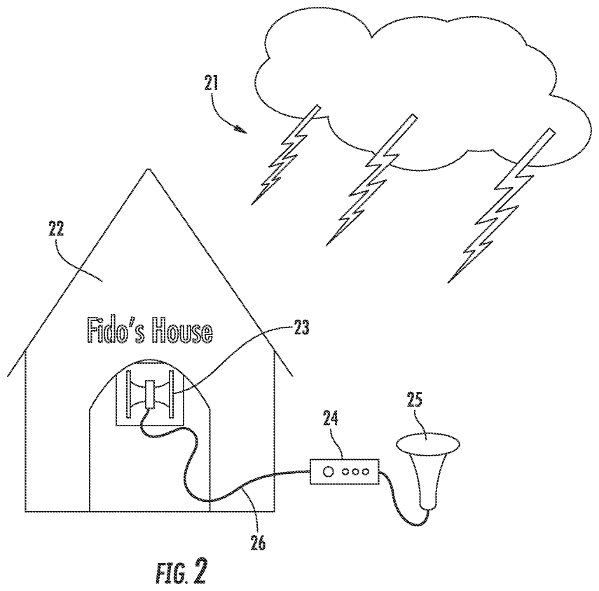

FIG. 2 is an embodiment for noise cancellation in an animal enclosure 22 of the present invention (in this embodiment, a dog house). In this embodiment, lightning 21 is creating thunderclaps and scaring Fido (dog). A device for collecting sound 25 from the thunderclap is positioned for such reception. A converter 24 converts the sound to a digital signal and is sent via cable 26 to the speaker system 23, canceling the noise for any animal in the enclosure.

Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings. Consequently, while the present invention has been described with reference to particular embodiments, modifications of structure, sequence, materials, and the like apparent to those skilled in the art still fall within the scope of the invention as claimed by the applicant.

What is claimed is:

1. A speaker system for equalizing pressure in a speaker enclosure comprising:
a) a full spectrum active speaker having two speaker cones, the speaker comprising:
i. a voice coil associated with each speaker cone, which creates an electromagnetic field from an audio signal passed through the voice coil; and
b) a single fixed magnet having a negative pole and a positive pole, wherein the negative pole is positioned at a rear end of one of the speaker cones, and wherein the positive pole is positioned at a rear end of the other speaker cone; and
c) a sealed enclosure for the speaker cones and magnet, wherein each of the speaker cones are exposed externally and connected to an audio source signal, which is 180° out of phase with the other.

2. The speaker system according to claim 1, wherein the speaker system is utilized to reproduce recorded sounds.

3. A speaker system for cancellation of a live noise in an animal enclosure comprising:
a) a full spectrum active speaker having two speaker cones, the speaker comprising:
i. a voice coil associated with each speaker cone, which creates an electromagnetic field from an audio signal passed through the voice coil; and
b) a single fixed magnet having a negative pole and a positive pole, wherein the negative pole is positioned at a rear end of one of the speaker cones, and wherein the positive pole is positioned at a rear end of the other speaker cone;
c) a sealed enclosure for the speaker cones and magnet, wherein each of the speaker cones are in a sealed enclosure and connected to an audio source signal, which is 180° out of phase with the other; and
d) a system for collection of the live noise, which system feeds the live noise to the speaker.

4. The speaker system according to claim 2, wherein the live sound is thunder.
